(19) United States
(12) Patent Application Publication
(10) Pub. No.: US 2009/0213241 A1
(43) Pub. Date: Aug. 27, 2009

(54) IMAGE PROCESSING APPARATUS, IMAGE PROCESSING METHOD, AND RECORDING MEDIUM

(75) Inventor: Shinichi FUKUEI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/391,478

(22) Filed: Feb. 24, 2009

(30) Foreign Application Priority Data
Feb. 26, 2008 (JP) 2008-044804

(51) Int. Cl. H04N 5/225; G06K 9/46

(52) U.S. Cl. 348/222.1; 382/190; 382/284; 348/E05.024

(57) ABSTRACT

An image processing apparatus includes an image acquisition unit configured to acquire a plurality of images, an object recognition unit configured to recognize an object of interest existing in any one of the images acquired by the image acquisition unit, a background evaluation unit configured to evaluate an image existing in an image area other than an image area showing the object of interest recognized by the object recognition unit, an object evaluation unit configured to evaluate any image existing in the image area showing the object of interest recognized by the object recognition unit, an image selection unit configured to select a plurality of images from the images in accordance with results of the evaluations performed by the background evaluation unit and object evaluation unit, and an image composition unit configured to compose a new image by using the images selected by the image selection unit.

### BACKGROUND OF THE INVENTION

1. Field of the Invention

The present invention relates to an image processing apparatus, an image processing method, and a recording medium, which generates new images from a plurality of images.

2. Description of the Related Art

Jpn. Pat. Appln. KOKAI Publication No. 2007-036586 (Patent Document 1) discloses a technique of first taking a high-quality still picture and a low-quality moving picture at the same time, and then generating a high-definition still image, at a good shutter-release timing, from the data representing, for example, the appearance of a person, i.e., object of photography. However, if two apparatuses for photographing a moving image and a still image, respectively, are packed in one camera, the camera will be not only expensive, but also large.

Japanese Patent No. 2828138 (Patent Document 2) proposes a technique of first detecting the relative displacement of a plurality of frame images taken by an photographing apparatus and then generating a high-definition image by using the data representing the displacement of the frame images.

Jpn. Pat. Appln. KOKAI Publication No. 2007-013269 (Patent Document 3) proposes a technique of switching the photographing mode to a consecutive photographing mode when the imaging conditions are bad, thereby to acquire a high-quality image from a plurality of frame images.

Jpn. Pat. Appln. KOKAI Publication No. 2007-013270 (Patent Document 4) proposes a technique of first switching the photographing mode to a pixel-mixed photographing mode when the imaging conditions are bad, and then changing the photographing sensitivity in accordance with the imaging conditions, thereby to acquire a low-noise, high-quality image.

Jpn. Pat. Appln. KOKAI Publication No. 2007-006427 (Patent Document 5) discloses a technique of inferring the direction to which the object turns the face or eyes, from the positional relation between the face area and the center of the face.

Jpn. Pat. Appln. KOKAI Publication No. 2004-294498 (Patent Document 6) proposes a method of recognizing the appearance of an object, in which the object is photographed when the object assumes a desirable appearance and takes a desirable pose.

If used to photograph an object moves in a specific manner, such as a person's face, the techniques disclosed in Patent Documents 2 to 4 may fail to provide a highly-correct image if the person does not face the camera, turns the eyes, shut the eyes or assumes an inappropriate appearance.

The techniques disclosed in Patent Documents 5 and 6 may provide an image that appears unnatural, showing a moving object (a non-interest object) along with the object and the background, if the non-interest object moves into the view field while the object is being photographed.

This invention has been made in view of the foregoing. An object of the invention is to provide an image processing apparatus, an image processing method, and a recording medium, which can generate, from a plurality of images, an image that looks as natural as possible, showing the background well harmonized with the image of the object.

### BRIEF SUMMARY OF THE INVENTION

An image processing apparatus according to an embodiment of this invention comprises: an image acquisition unit configured to acquire a plurality of images; an object recognition unit configured to recognize an object of interest existing in any one of the images acquired by the image acquisition unit; a background evaluation unit configured to evaluate an image existing in an image area other than an image area showing the object of interest recognized by the object recognition unit; an object evaluation unit configured to evaluate any image existing in the image area showing the object of interest recognized by the object recognition unit; an image selection unit configured to select a plurality of images from the images in accordance with results of the evaluations performed by the background evaluation unit and object evaluation unit; and an image composition unit configured to compose a new image by using the images selected by the image selection unit.

An image processing method according to another embodiment of the invention comprises: an image acquisition step of acquiring a plurality of images; an object recognition step of recognizing an object of interest existing in any one of the images acquired by the image acquisition step; a background evaluation step of evaluating an image existing in an image area other than an image area showing the object of interest recognized in the object recognition step; an object evaluation step of evaluating any image existing in the image area showing the object of interest recognized in the object recognition step; an image selection step of selecting a plurality of images from the images in accordance with results of the evaluations performed in the background evaluation step and object evaluation step; and an image composition step of composing a new image by using the images selected by the image selection unit.

A recording medium according to still another embodiment of the invention is designed to record electronically an image processing program for generating a new image from a plurality of images is electronically recorded. The program describes: an image acquisition process of acquiring a plurality of images; an object recognition process of recognizing an object of interest existing in any one of the images acquired in the image acquisition process; a background evaluation step of evaluating an image existing in an image area other than an image area showing the object of interest recognized in the object recognition process; an object evaluation process of evaluating any image existing in the image area showing the object of interest recognized in the object recognition process; an image selection process of selecting a plurality of images from the images in accordance with results of the evaluations performed in the background evaluation process and object evaluation process; and an image composition process of composing a new image by using the images selected in the image selection process.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an image processing apparatus according to a first embodiment of this invention;

FIG. 2 is a flowchart illustrating the main routine of an image processing according to the first embodiment;

FIG. 3A is a flowchart showing the process of evaluating the image of an object, which is performed in the first embodiment;

FIG. 3B is a flowchart showing, in detail, the process of evaluating the image of the object's face to determine whether the object is fronting on the photographing apparatus;

FIG. 3C is a schematic representation of the face area of the object;

FIG. 4 is a diagram showing an exemplary elliptical face model according to the first embodiment;

FIG. 5 is a diagram representing an angle Φ face measured in the horizontal plane, an angle Ψ face measured in the vertical plane, and an orientation θ measured in the horizontal plane, all with respect to the photograph apparatus according to the first embodiment;

FIG. 6 is a flowchart showing, in detail, the process of evaluating the direction in which the object is viewing something, in Step S204 of FIG. 3A;

FIG. 7 is a diagram showing an eye model that defines the variables used in the first embodiment, in order to calculate the direction in which the object is viewing something;

FIG. 8 is a block diagram illustrating the configuration of the intra-frame evaluation unit according to the first embodiment;

FIGS. 9A and 9B are diagrams showing the images representing the results of the intra-frame evaluation according to the first embodiment;

FIG. 10 is a diagram showing exemplary images that explain the results of the inter-frame evaluation according to the first embodiment;

FIG. 11 is a diagram explaining how the inter-frame evaluation is performed by using an optical flow according to the first embodiment;

FIG. 12 is a diagram explaining how the inter-frame evaluation is performed by using differential images according to the first embodiment;

FIG. 13 is a flowchart showing the process sequence of inferring a motion in the first embodiment;

FIG. 14 is a diagram exemplifying a similarity map prepared for use in inferring a motion in the first embodiment;

FIG. 15 is a diagram illustrating how an image of interest gradually approximates to a reference image in the first embodiment;

FIG. 16 is a diagram representing the concept of acquiring a high-resolution image by performing the first averaging method according to the first embodiment;

FIG. 17 is a diagram representing the concept of acquiring a high-resolution image by performing the second averaging method according to the first embodiment;

FIG. 18 is a block diagram showing the configuration of an image processing apparatus according to a second embodiment of this invention;

FIG. 19 is a flowchart illustrating the main routine of an image processing according to the second embodiment;

FIG. 20 is a diagram illustrating the sequence of processing an image of the object's face in the second embodiment;

FIG. 21 is a block diagram showing the configuration of an image processing apparatus according to a third embodiment of this invention;

FIG. 22 is a flowchart illustrating the main routine of an image processing according to the third embodiment; and

FIG. 23 is a diagram illustrating the sequence of processing an image in the third embodiment.

### DETAILED DESCRIPTION OF THE INVENTION

Best modes of the present invention will be described with reference to the accompanying drawings.

### First Embodiment

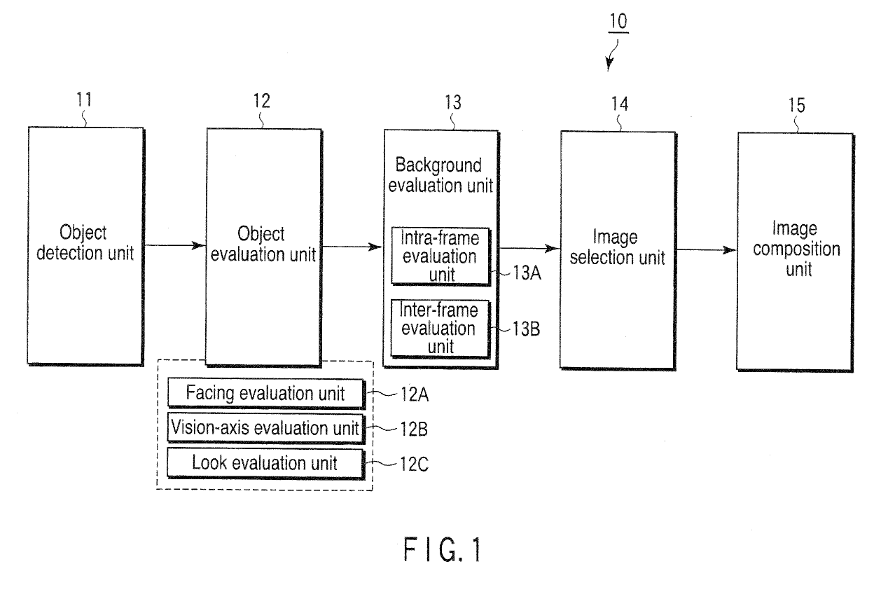

FIG. 1 is a diagram showing the configuration of an image processing apparatus 10 according to a first embodiment of the present invention. As FIG. 1 shows, the image processing apparatus 10 comprises an object detection unit 11, an object evaluation unit 12, a background evaluation unit 13, an image selection unit 14, and an image composition unit 15.

The object detection unit 11 detects a specific object from a plurality of frame images acquired by a photographing apparatus (not shown), such as a digital camera, which is provided outside the image processing apparatus 10.

The object evaluation unit 12 evaluates the object the object detection unit 11 has detected. The object evaluation unit 12 includes a facing evaluation unit 12A, a vision-axis evaluation unit 12B, and a appearance evaluation unit 12C.

The background evaluation unit 13 evaluates a part of the image, which is other than the area the object detection unit 11 has detected. The background evaluation unit 13 includes an intra-frame evaluation unit 13A and an inter-frame evaluation unit 13B. The intra-frame evaluation unit 13A evaluates frame images, one by one. The inter-frame evaluation unit 13B evaluates a plurality of frame images, from the relation they have with other frame images.

The image selection unit 14 selects the image that the background evaluation unit 13 has evaluated most highly.

The image composition unit 15 composes a plurality of images, using images that include at least the image selected by the image selection unit 14.

The image composition unit 15 may be constituted by a high-resolution image generating device that is configured to generate a high-definition image from a plurality of images. In this case, the image composition unit 15 includes a motion inference unit and a high-resolution process unit. The motion inference unit infers the motion of each image (frame) from one frame to another, from the signals representing several images. The high-resolution process unit performs a process of generating a high-resolution image by using several low-resolution images that are displaced from one another as disclosed in Patent Document 2.

In this embodiment, the image composition unit 15 performs the process of generating a high-resolution image from low-resolution images. According to this invention, the image composition unit 15 may instead perform an ordinary noise-removing process or a broad dynamic-range imaging process, either using signals representing several images.

How this embodiment operates will be explained.

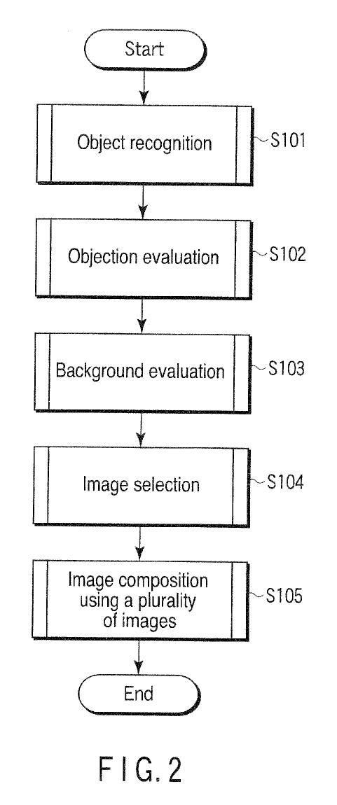

FIG. 2 is a flowchart illustrating the main routine performed in the image processing apparatus 10.

First, a plurality of frame images is acquired from an external photographing apparatus. The object detection unit 11 performs a process of recognizing a specific object (Step S101).

How the object detection unit 11 recognizes the specific object that is, for example, a person's face, will be explained in detail.

The object detection unit 11 first extracts, from a plurality of frame images, the frame images that represent the face. These frame images may be extracted by any face-detecting method known in the art. One known method is disclosed in P. Voila and M. Jones, “Rapid object detection using a boosted cascade of simple features,” Proc. of CVPR, 2001. The Voila-Jones method is a method in which a rectangular filter optimal for detecting faces, which has been selected through the learning of Adaboost, is correlated with an image, thereby to detect a face in the image.

The object evaluation unit 12 evaluates the object detected by the object detection unit 11. How the unit 12 evaluates the object will be explained below.

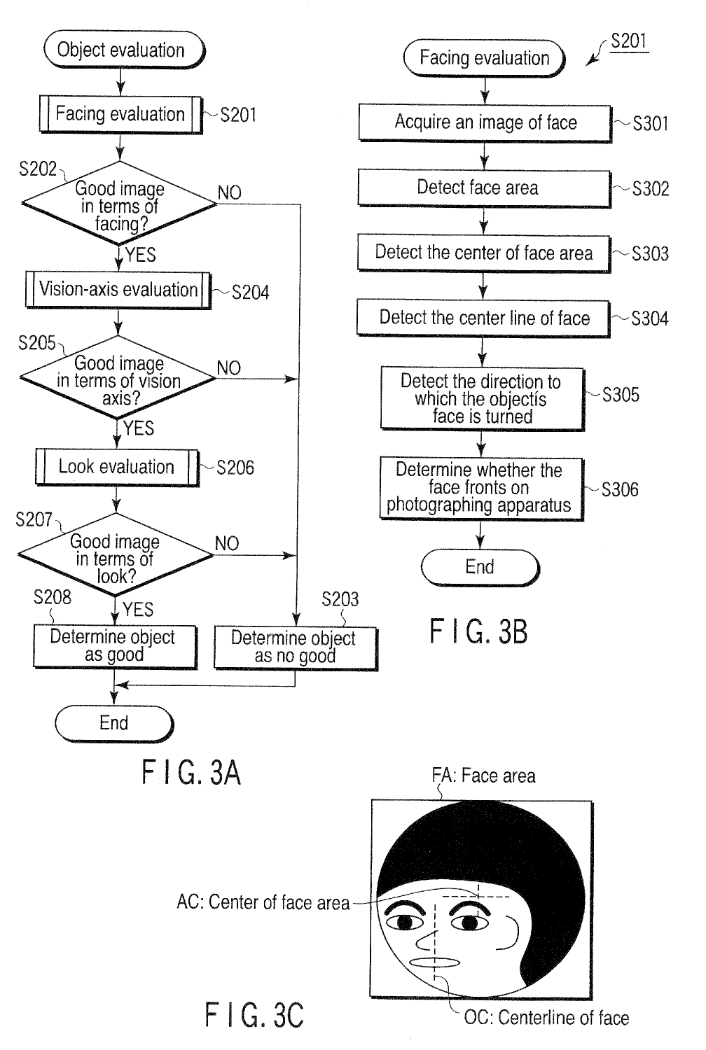

FIG. 3A is a flowchart showing the process that the object evaluation unit 12 performs to evaluate the image of an object.

First, the facing evaluation unit 12A performs a facing evaluation process, determining whether the object's face in the frame image is fronting on the photographing apparatus (Step S201). The facing evaluation process will be described later in detail. Then, whether the object's face is fronting on the photographing apparatus is determined (Step S202). If the object's face is found not to be fronting on the photographing apparatus (if NO in Step S202), the frame image is evaluated as no good (Step S203).

The object's face may be found to be fronting on the photographing apparatus (that is, YES in Step S202). In this case, the vision-axis evaluation unit 12B performs a vision-axis valuation process (Step S204). The vision-axis evaluation process will be described later in detail.

Next, it is determined whether the object's vision-axis is appropriate (Step S205). If the object's vision-axis is found not to be appropriate (if NO in Step S205), the frame image is evaluated as no good (Step S203).

The object's vision-axis may be found to be appropriate (that is, YES in Step S205). If this is the case, the appearance evaluation unit 12C performs a appearance evaluation process (Step S206). The look evaluation process will be described later in detail.

It is then determined whether the object's appearance is appropriate (Step S207). If the object's appearance is found not to be appropriate (if NO in Step S207), the frame image is regarded as no good (Step S203).

The object's appearance may be found to be appropriate (that is, YES in Step S207). That is, the frame image may be evaluated as good in the facing evaluation process (Step S202), the vision-axis valuation process (Step S204) and the appearance evaluation process (Step S206). In this case, the frame image is finally evaluated as good and will then be subjected to the high-resolution process.

The facing evaluation process will be described now.

In the facing evaluation process, the direction the object is facing is inferred, employing the process of positioning the center of the object's face, as disclosed in Patent Document 5. An image showing the object's face fronting on the photographing apparatus can thereby be selected.

A method of calculating the direction to which the object in the image turns the face, which is proposed in Patent Document 5, will be described. In this method, the object detection unit 11 detects an image showing the object's face, measures the facing direction and generates the data representing the direction.

FIG. 3B is a flowchart showing, in detail, the process of evaluating the image of the face to determine whether the object is fronting on the photographing apparatus.

First, the object detection unit 11 acquires that part of the frame image detected by the image processing apparatus 10, which seems to the image of the object's face, is acquired (Step S301). Then, the object detection unit 11 extracts the differential background and the skin-color area, detecting the face area FA at high precision (Step S302). Note that the face area FA is the square region that circumscribes the image of the object's head in the frame image, as is illustrated in FIG. 3C.

Next, the object detection unit 11 detects the center AC of the face area FA (Step S303). Further, the unit 11 detects the positions of the facial features, such as the eyebrows, corners of the eyes and the nose, thus determining the position of the center line OC of the object's face (Step S304).

As can be seen from FIG. 3C, the center AC is the of the face area FA and the center line OC is a line that connects the midpoint between the eyebrows, the dorsum centerline of the nose and the middle part of the upper lip.

From the center AC of the face area FA and the center line OC of the object's face, the object detection unit 11 calculates the direction to which the object is turning the face (Step S305).

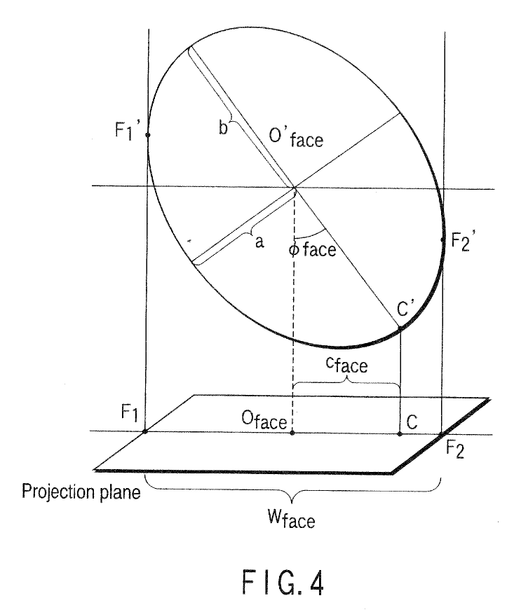

More precisely, the facing direction in the horizontal plane is first calculated, using such an elliptical face mode as shown in FIG. 4. FIG. 4 shows an image of the object's head as viewed from above while the object's face turns to the right a little by angle Φ face in the horizontal plane.

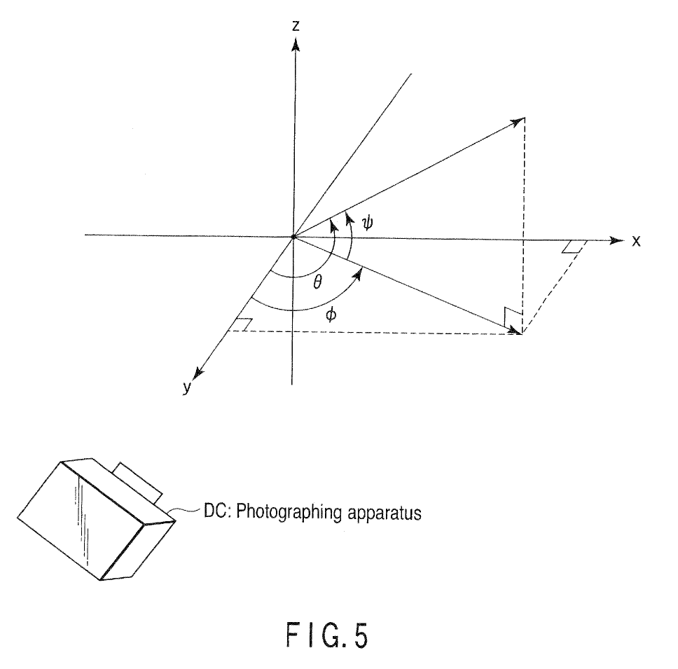

FIG. 5 is a diagram representing the angle Φ face measured in the horizontal plane, the angle Ψ face measured in the vertical plane, and an orientation θ measured in the horizontal plane, all with respect to the photograph apparatus DC.

The angle Φ face measured in the horizontal plane with respect to the photographing apparatus DC is given as shown in the following equation (1). In the equation (1), k is elliptical ratio and elliptical ratio k=1.25 is applied in the technique disclosed in Patent Document 5.

$${Φ}_{face} = {sin}^{- 1} \frac{{C}_{face}}{( \frac{{W}_{face}}{2} + \vert {C}_{face} \vert ) K + \vert {C}_{face} \vert} \qquad ( 1 )$$

To infer the angle Ψ face to the apparatus DC, measured in the vertical plane, a method known in the art is employed.

Whether the face is turned to the photographing apparatus DC is determined from the angle Φ face measured in the horizontal plane and the angle Ψ face measured in the vertical plane. The orientation θ is the angle θ face between the direction in which the face turns to the apparatus DC and the optical axis of the photographing apparatus DC. The angle θ face is calculated, using the following equation (2).

$${θ}_{face} = {sin}^{- 1} \sqrt{{sin}^{2} {Φ}_{face} {cos}^{2} {ψ}_{face} + {sin}^{2} {ψ}_{face}} \qquad ( 2 )$$

The facing direction is thus calculated. Then, whether the object's face is fronting on the photographing apparatus DC is determined in accordance with the facing direction calculated (Step S306). More specifically, the object's face is found to front on the apparatus DC if the angle θ face ≦30. Thus, the frame image is regarded as good.

The vision-axis valuation process (Step S204) on the image found to be good in the facing evaluation process (Step S202) will be explained.

The vision-axis valuation process is performed, using the method disclosed in Patent Document 5. In the vision-axis valuation process, the value obtained in the facing evaluation process is applied, too.

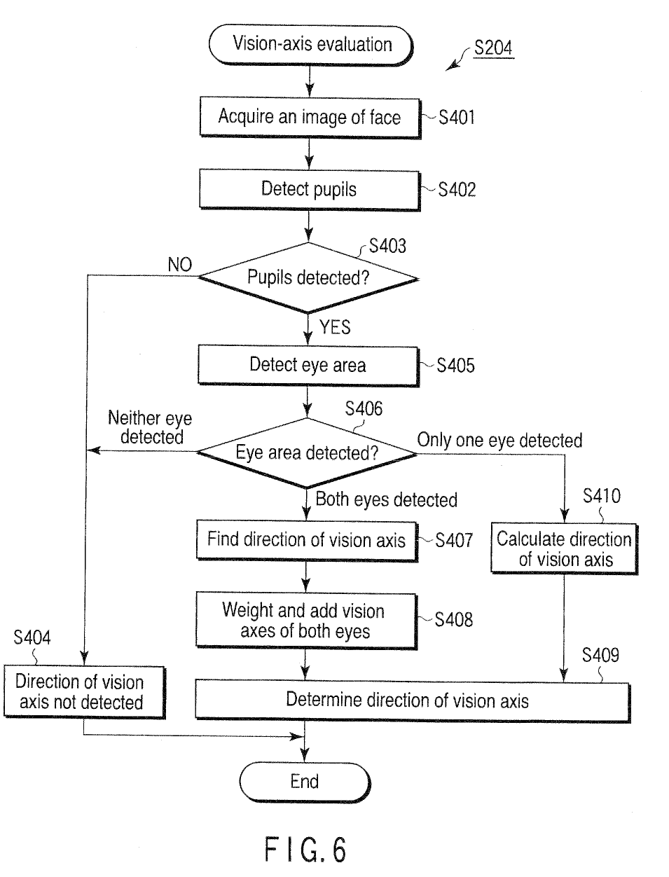

FIG. 6 is a flowchart showing the vision-axis evaluation process.

First the face image is extracted from the image regarded as good in the facing evaluation process (Step S401). Next, the images of the pupils are detected from the image extracted (Step S402). Whether any pupil has been detected is determined (Step S403). If no pupils have been detected, it is determined that the direction in which the object is looking at something has not been detected (Step S404).

If any pupil has been detected in Step S403, the eye area is detected (Step S405). More precisely, whether the images of both eyes, the image of only one eye or the image of neither eye has been detected is determined (Step S406).

If both eyes have been detected in Step S405, the directions the vision axes of the eyes are calculated (Step S407). These directions are weighted and then added, thereby determining a vision axis common to the eyes (Step S408). A vision axis, i.e., direction in which the object is viewing something, is thereby determined (Step S409).

Only one eye may be detected in Step S406. In this case, the vision axis of this eye is calculated (Step S410). The direction in which the object is viewing something is thereby determined (Step S409).

Neither eye may be detected in Step S406. If this is the case, it is determined that the direction in which the object is viewing something has not been detected (Step S404).

The vision-axis evaluation process shown in FIG. 6 is performed, using only the image that has been regarded as good in Step S201 during the facing evaluation process. Hence, it can hardly be determined in Step S406 that only one eye has been detected, if the object's face is found to be fronting on the photographing apparatus DC in the facing evaluation process (FIG. 3B). Therefore, the vision axis can be considered to have failed, if only one is detected in Step S206.

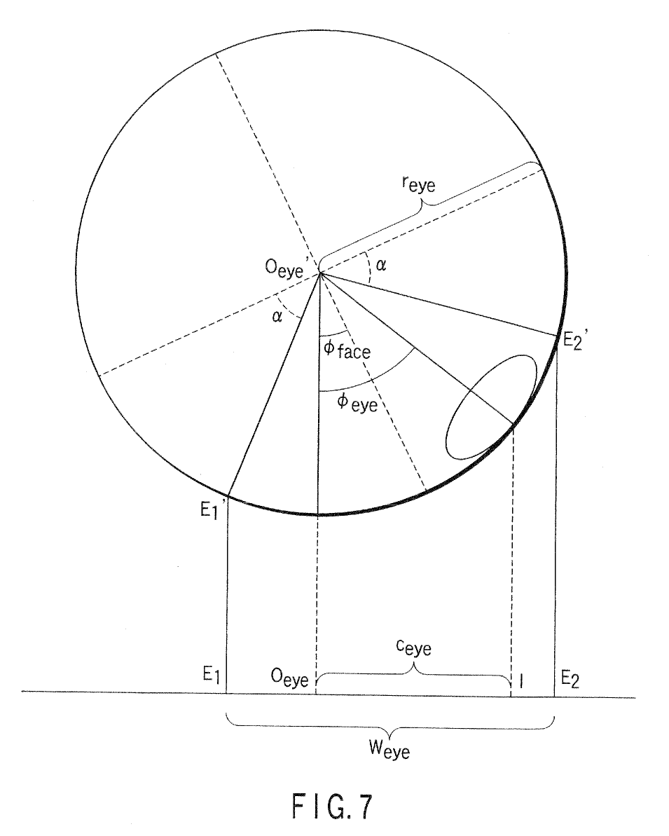

A method of calculating in Steps S407 and S410 the direction in which the object is viewing something will be explained, using an eye model illustrated in FIG. 7.

The eyes are usually covered, in part, with the skin. Therefore, only that part of either eye, which is defined by arc E1′-E2′ shown in FIG. 7. This part corresponds to the cornea. In FIG. 7, Oeye, and I indicate, respectively, the center of the eye and center of the pupil, both existing in the image of the eye, and Eeye′ indicates the actual center of the eye. In FIG. 7, too, Φ face is the angle calculated in the facing evaluation process, and Φeye is the angle at which the vision axis extends, Weye is the width of the eye area, and Ceye is the distance between the center of the eye and the center of the pupil.

The angle Φeye is expressed by the following equation (3):

$$sin {Φ}_{eye} = \frac{2 cos {Φ}_{face} cos α}{{W}_{eye}} ( I - {E}_{1} ) - cos ( α + {φ}_{face} ) \qquad ( 3 )$$

where α is the angle defined by that part of the eye, which is covered with the skin. Note that α is a known value set for the eye.

Both eyes may be detected in Step S406. In this case, the directions of the vision axes of the eyes are detected (Step S407). These directions are weighted and then added, thereby determining a vision axis common to the eyes (Step S408). A vision axis, i.e., direction in which the object is viewing something, is finally determined (Step S409).

How much the directions are weighted is determined by the direction to which the object is turning the face. If the object's face is turned to the right, the right eye will scarcely appear in the image. In this case, the direction of the vision axis of the left eye is greatly weighted. If the object's face is fronting on the photographing apparatus DC, the average direction of the vision axes of both eyes will be used. If this method is used in the image processing apparatus 10 according to the present embodiment, the vision-axis evaluation process (FIG. 6) is performed on only the image of the object's face, which has been regarded as a good one in the facing evaluation process (FIG. 3B). In view of this, the average direction of the vision axes of both eyes can be applied.

The directions of the vision axes of both eyes are determined in both the vertical plane and the horizontal plane.

Only the images, each showing the object's eyes having vision axes directed to the photographing apparatus DC, should be detected. To this end, any image showing the vision axes at an angle deviating by 5 from the correct value, in both the vertical plane and the horizontal plane, is regarded as a good one.

Thereafter, the appearance evaluation process (Step S206) is performed on any image regard as a good one in both the facing evaluation process (FIG. 3B) and the vision-axis evaluation process (FIG. 6). The appearance evaluation process may be performed by using a shape extracting method. The shape extracting method can be the Snackes method described in Patent Document 6, in which the appearance of a person is determined from the contour of the face, eyes and mouth of the person. Assume that the Snackes method is used in the present embodiment, in order to determine the appearance that the object has in any image.

Which appearance of the object should be considered to be good depends on the use of the image (i.e., photograph). An image in which the object is smiling is regarded as good if it will be used as a memorial photo. On the other hand, an image in which the object's face looks rather impassive is regarded as good if it will be used as an ID photo.

So evaluated as described above, the object's image in the image, particularly if regarded as representing the facial characteristics well, will be selected in all probability. This increase the possibility that the user acquires any desirable image through the image composition process that is subsequent to the image valuation processes.

Further, that area of the image, in which the object's face exists, will most probably be selected as representing the object of photography, because this area has been detected and evaluated. In addition, the user can have high probability of acquiring any desirable image through the image composition process subsequent to the image valuation processes, because the image of the object's face has been evaluated by using the established technique of evaluating images in accordance with the positional relation of the facial features, such as the eyes, nose and mouth.

The main routine of FIG. 2 will be explained further. The background evaluation is performed to evaluate the area other than the face area FA (Step S103). The background evaluation will be described in detail.

As described above, that area of the image, in which the image of the object exists, is evaluated to evaluate the object's image. By contrast, the background evaluation is concerned with the area of the image, which is other than the object area. As explained with reference to FIG. 1, the background evaluation unit 13 includes an intra-frame evaluation unit 13A and an inter-frame evaluation unit 13B.

The intra-frame evaluation unit 13A is configured to evaluate the texture of the background. Any image having no texture is unfit to be converted to a high-resolution image. Therefore, the intra-frame evaluation unit 13A evaluates any image having texture, as a good image.

The inter-frame evaluation unit 13B excludes any one of the frame images, in which the background has greatly changed. A motion of an image of a car, which is not the object of interest and a change in the ambient lighting, can be exemplified as great changes in the background.

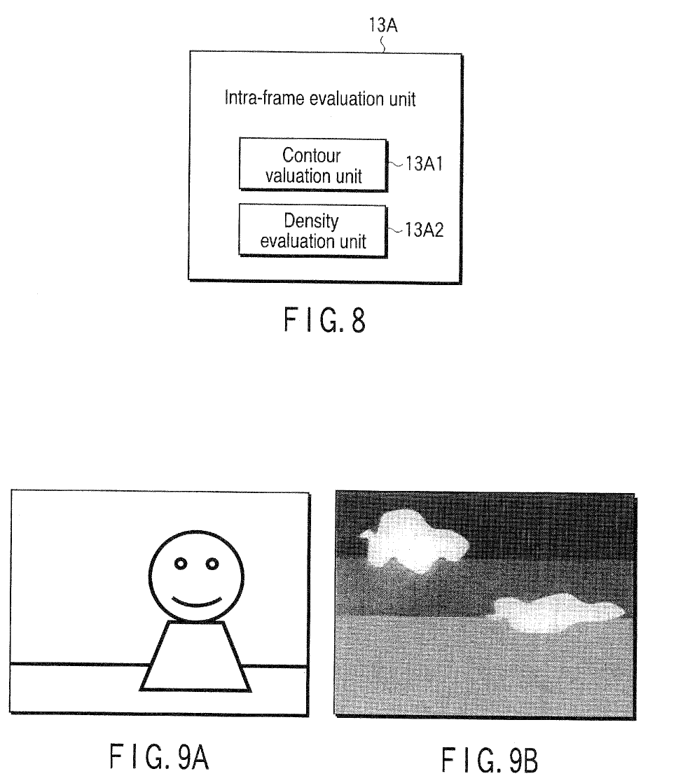

How the intra-frame evaluation unit 13A will be explained first. As shown in FIG. 8, the intra-frame evaluation unit 13A has a contour valuation unit 13A1 and a density evaluation unit 13A2.

The contour valuation unit 13A1 determines whether the contours are clearly shown as shown in FIG. 9A. The density evaluation unit 13A2 determines whether the image is non-uniform in luminance as shown in FIG. 9B.

The contour valuation unit 13A1 determines whether the contours are clearly shown, in terms of the intensity of edges. The density evaluation unit 13A2 determines whether the image is non-uniform in luminance, in terms of the luminance distribution in the image. The contour valuation unit 13A1 and the density evaluation unit 13A2 cooperate to evaluate any background accurately, no matter whatever pattern the background has.

Hence, any image that has texture so characterized as mentioned above can be easily evaluated and can therefore be converted to a high-resolution image as will be described later.

The inter-frame evaluation will be explained.

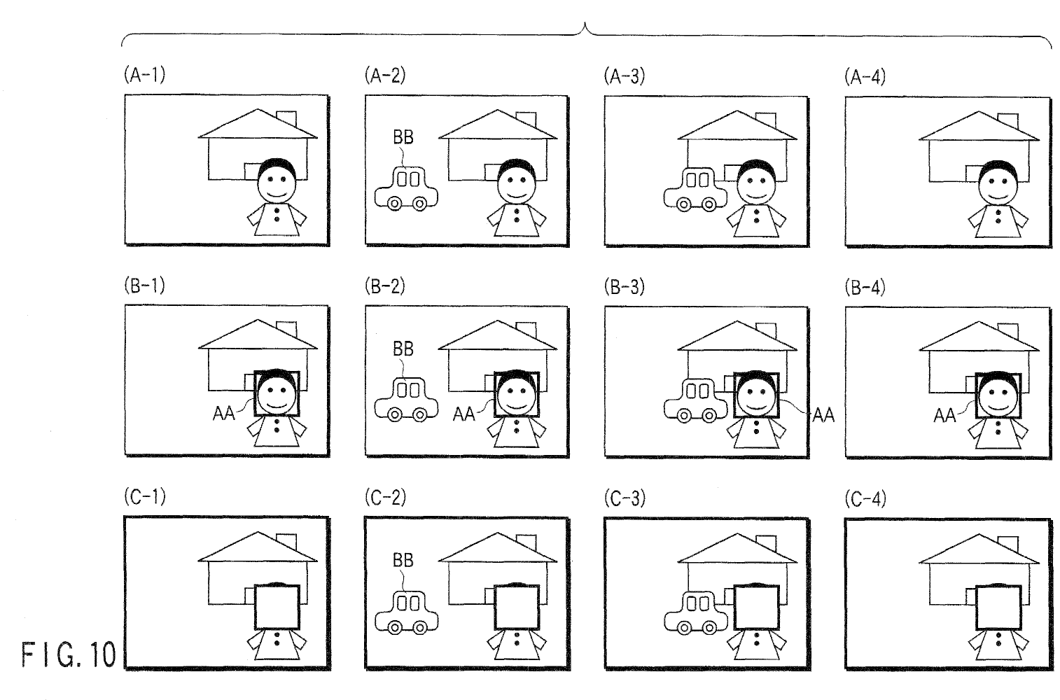

Let us consider an image composed of a plurality of frames and showing an object of interest and a moving image, as shown at (A-1) to (A-4) in FIG. 10.

Shown at (B-1) to (B-4) in FIG. 10 are frame images, in each of which the object-of-interest area AA is designated. Shown at (C-1) to (C-4) in FIG. 10 are frame images, in each of which the object-of-interest area AA has been deleted. The frame images shown at (C-1) to (C-4) in FIG. 10 are subjected to the inter-frame evaluation.

The leftmost frame image shown at (C-1) in FIG. 10 has no images of car BB. An image of car BB is shown in the second frame image, as shown at (C-2) in FIG. 10.

In the third frame image shown at (C-3) in FIG. 10, the image of car BB exists at a position different from the position in the second frame image. This is because the image of car BB moves at a certain speed. In the fourth frame image shown at (C-4) in FIG. 10, the image of car BB no longer appears because car BB has moved out of the view field of the photographing apparatus DC.

The inter-frame evaluation determines that the first frame image of FIG. 10(C-1) and the fourth frame image of FIG. 10(C-4) are identical, except for the object-of-interest area AA.

By contrast, the inter-frame evaluation determines that the first frame image and the second frame image shown at shown at (C-1) and (C-2) in FIG. 10, respectively, are not identical, except for the object-of-interest area AA. The first frame image and the second frame image are determined as such, because they are considered to greatly differ in pixel value in view of the calculated difference between them.

Of the consecutive frame images, any one in which the background greatly changes is plucked out. An image can therefore be generated, which is free of the influence of changes, such as the motion of a car that is not the object of interest, and the change in the ambient lighting.

In addition, the inter-frame evaluation enables the image composition unit 15 to generate an image of higher definition.

Any image having a background found good by the intra-frame evaluation unit 13A or the inter-frame evaluation unit 13B, or both, is considered to be a good one.

The intra-frame evaluation unit 13A and the inter-frame evaluation unit 13B utilize each other's advantage, thus cooperating to evaluate images of various types of objects.

The inter-frame evaluation unit 13B can use an optical flow to evaluate images. How the unit 13B evaluate image by using the optical flow will be explained below.

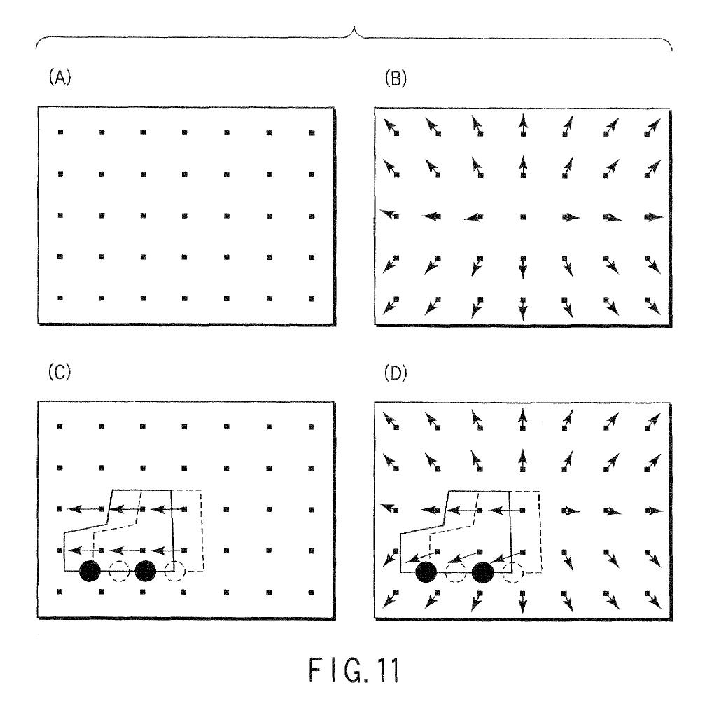

How a still object is photographed in moving-picture photographing mode will be explained with reference to FIG. 11. As shown at (A) in FIG. 11, each motion vector in the optical flow is 0 if neither the object nor the background moves and the photographing apparatus DC does not move, either. If the photographing apparatus DC moves and neither the object nor the background moves, any motion vector has almost the same magnitude as the adjacent vectors as shown at (B) in FIG. 11.

A part of the object may move while the photographing apparatus DC remains still. In this case, a motion vector exists at only the moving part of the object, as shown at (C) in FIG. 10. If a part of the object moves and the photographing apparatus DC moves, too, the vector for the moving part of the object will much differ from the adjacent moving vector, as shown at (D) in FIG. 10.

The vision-axis evaluation unit 12B evaluates the background shown in at (A) and (B) in FIG. 10, as a good one, and the background shown at (C) and (D) in FIG. 10, as no good.

Thus using the optical flow, the object evaluation unit 12 can accomplish the inter-frame evaluation.

How the inter-frame evaluation unit 13B performs inter-frame evaluation using differential images will be explained below.

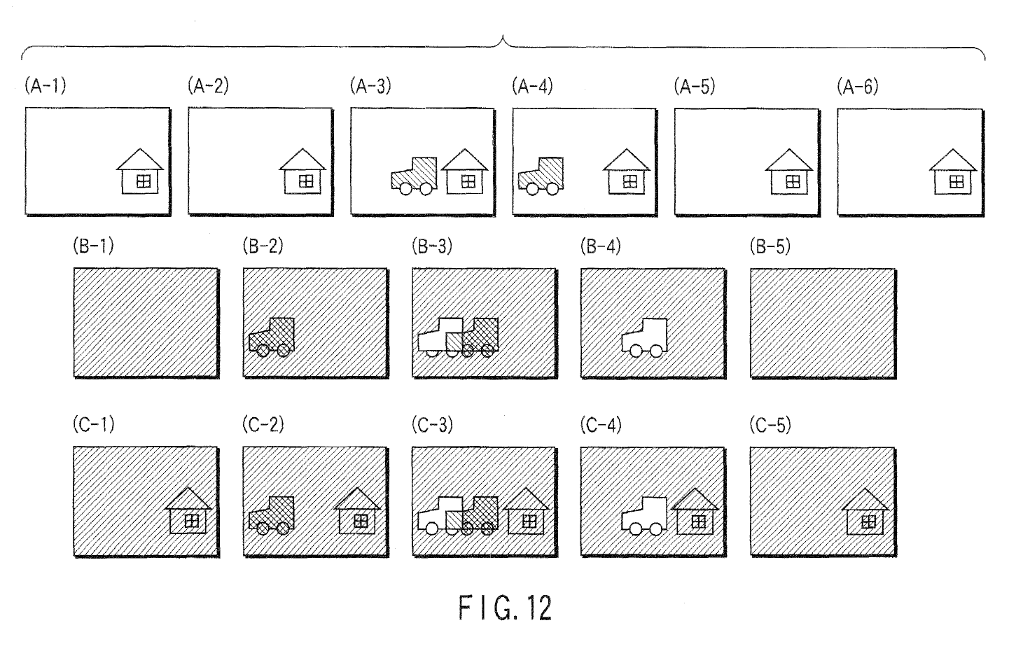

Assume there are six consecutive frame images in time sequence, as shown at (A-1) to (A-6) in FIG. 12. These frame images have obtained by photographing a house, i.e., a still object, while a car was passing by. Note that the car does not appear in the images shown at (A-1), (A-2), (A-5) and (A-6) in FIG. 12.

In this case, a differential image is generated, representing the difference between any two adjacent frame images. That is, five differential images are generated, for images shown at (A-1) and (A-2), images shown at (A-2) and (A-3), images shown at (A-3) and (A-4), images shown at (A-4) and (A-5), and images shown at (A-5) and (A-6).

If the photographing apparatus DC did not move at all at the time of photographing, the differential image for images shown at (A-1) and (A-2) is the image shown at (B-1) in FIG. 12; the differential image for images shown at (A-2) and (A-3) is the image shown at (B-2) in FIG. 12; the differential image for images shown at (A-3) and (A-4) is the image shown at (B-3) in FIG. 12; the differential image for images shown at (A-4) and (A-5) is the image shown at (B-4) in FIG. 12; the differential image for images shown at (A-5) and (A-6) is the image shown at (B-5) in FIG. 12.

Assume that the photographing apparatus DC was held in the hand and the hand moved while the frame images were being taken. If the apparatus DC moved but very little, the difference in position of the still object (i.e., house), between any frame image and the next frame image is very small as seen from the images shown at (C-1) to (C-5) in FIG. 12, and the difference in position of the moving object (i.e., car) is conversely large as seen from the image shown at (C-3) in FIG. 12.

Hence, if the photographing apparatus DC moved a little at the time of photographing, the differential image for images shown at (A-1) and (A-2) is the image shown at (C-1) in FIG. 12; the differential image for images shown at (A-2) and (A-3) is the image shown at (C-2) in FIG. 12; the differential image for images shown at (A-3) and (A-4) is the image shown at (C-3) in FIG. 12; the differential image for images shown at (A-4) and (A-5) is the image shown at (C-4) in FIG. 12; the differential image for images shown at (A-5) and (A-6) is the image shown at (C-5) in FIG. 12.

If the dispersion of the differential image is taken into account, the moving object can be detected, no matter whether the photographing apparatus DC was moving a little or remained still.

In addition, each frame Image can be easily evaluated because a differential image is calculated first by converting the image data to binary data, using a particular threshold value, then by detecting a greatly changing part of the frame image and finally by finding the ratio of the greatly changing part to the entire frame image. This reduces the load on the background evaluation unit 13, minimizing the amount of data the inter-frame evaluation unit 13B of the inter-frame evaluation unit 13B must process to accomplish the inter-frame evaluation.

In the main routine show in FIG. 2, the image selection unit 14 selects an image that has been highly evaluated in the object evaluation unit 12 or the background evaluation unit 13, or both, after the background has been evaluated (Step S103).

The results of both object evaluation and the result of background evaluation are thus utilized. That is, the object evaluation and the background evaluation utilize each other's advantage, thus processing more images than otherwise.

From a plurality of images the image selection unit 14 has selected, the image composition unit 15 synthesizes a high-resolution image (Step S104).

One of the processes the image composition unit 15 may perform to generate a high-resolution image is disclosed in, for example, Patent Document 3. The present embodiment employs the method disclosed in Patent Document 3.

The sequence of the process of generating a high-resolution image will be explained below.

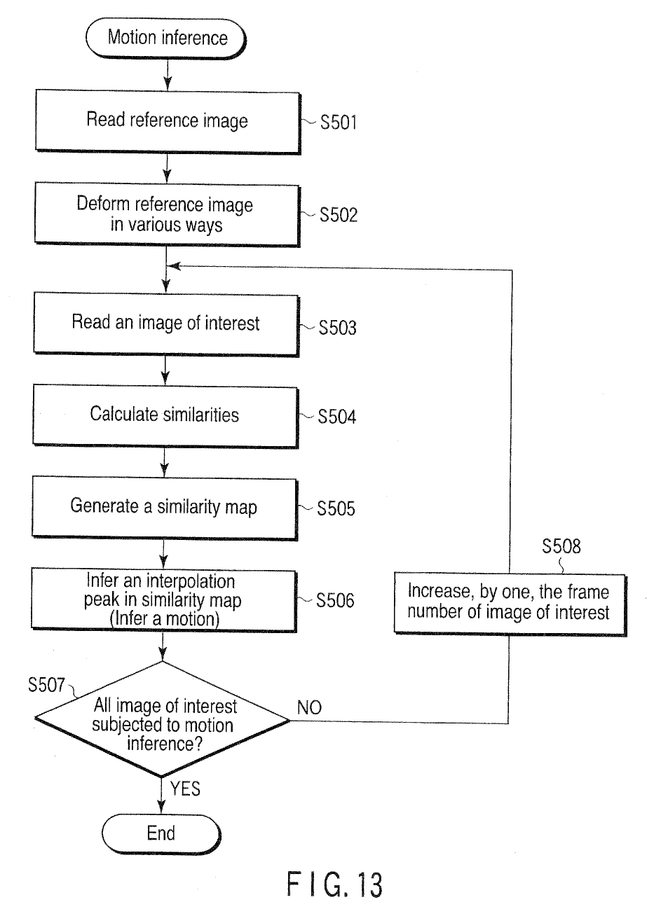

The process the image composition unit 15 converts an image to a high-quality image includes a motion inference process and an averaging process. The motion inference process and the averaging process will be explained with reference to FIG. 13 to FIG. 17.

The process the image composition unit 15 uses a plurality of images the object evaluation unit 12 has determined as good ones, inferring an inter-frame motion.

FIG. 13 is a flowchart showing the sequence of inferring a motion.

First, an image that will be used as a reference for motion inference is read (Step S501). The image read (hereinafter referred to as “reference image”) is deformed in various ways, providing a plurality of motion images, each representing a motion (Step S502).

Next, one image of which a motion should be inferred (hereinafter called “image of interest”) is read (Step S503). The similarity between the image of interest and each of the motion images is calculated (Step S504). A discrete similarity map is generated from the relation the parameters of the motion images have with the similarities calculated (Step S505).

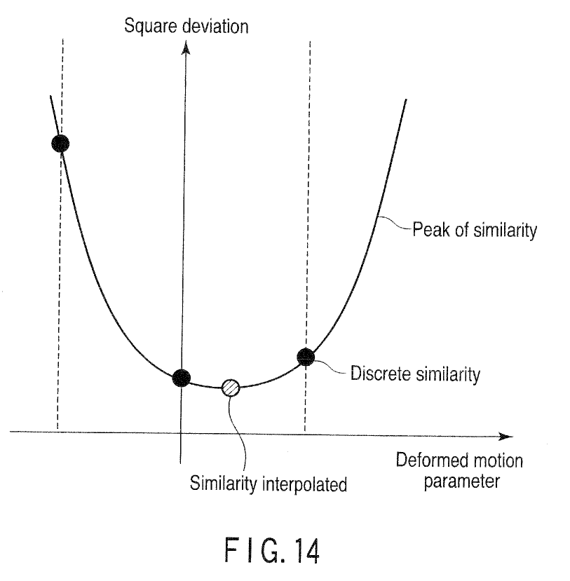

FIG. 14 shows an example of a similarity map that may be used in parabolic fitting for accomplishing motion inference. In FIG. 14, the square deviation is plotted on the ordinate, and deformed motion parameter is plotted on the abscissa. The smaller the square deviation, the higher the similarity will be.

In Step S502, the reference image is deformed in 19 ways, using motion parameters in units of ±1 pixel, for example, in the horizontal, vertical and rotation directions. (Of the 27 ways available, eight ways are identical deformation patterns.)

In Step S502, too, discrete similarity values (−1, +1, -1), (−1, +1, 0) and (−1, +1, +1) are plotted from the negative side, on the assumption that the motion parameter plotted on the abscissa (FIG. 14) is a combination of three motions in the horizontal, vertical and rotation directions. The discrete similarity values will be (−1), (0) and (+1) from the negative side, plotted for the horizontal, vertical and rotational directions, respectively, if the directions in which to deform the reference image are considered independently.

Thereafter, the discrete similarity map generated in Step S505 is interpolated, a peak is detected in the map, and the peak value is detected (Step S506). The deformation determined from the peak value detected is equivalent to the motion inferred. The peak value may be detected in the similarity map by means of spline interpolation, instead of the above-mentioned parabolic fitting.

Then, whether all image of interests available have been subjected to the motion inference (Step S507). If all image of interest have not been subjected to the motion inference, the frame number for the image of interest is increased by one (Step S508). The process then return to Step S503. Thus, Steps S503 to S508 are repeatedly performed until all image of interest undergo the motion inference.

All image of interest may be found to have been subjected to the motion inference (that is, YES in Step S507). In this case, the motion inference process is terminated.

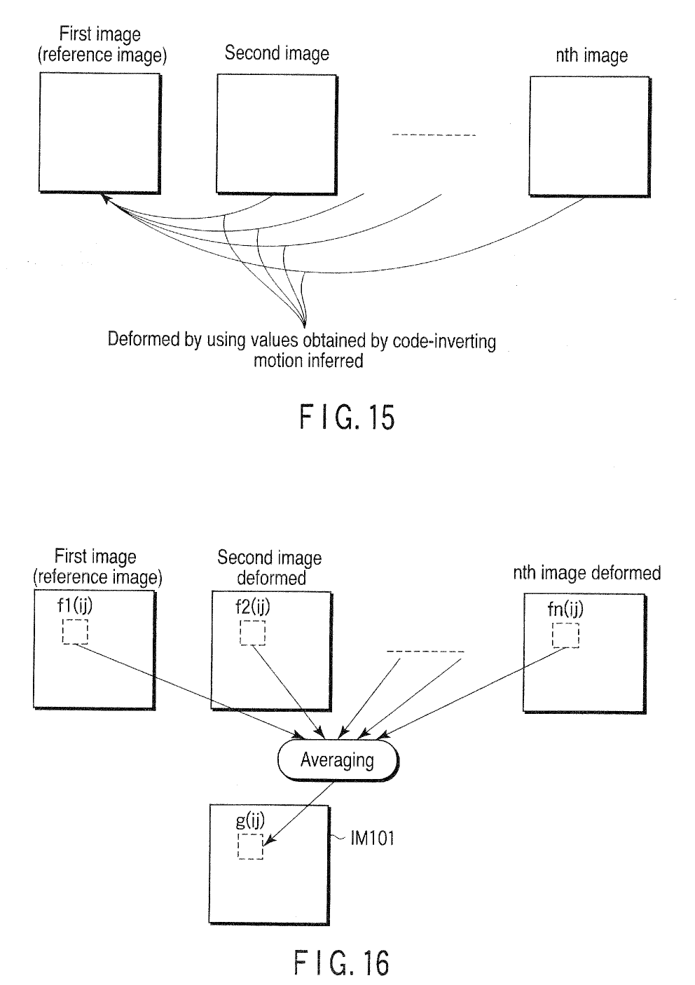

FIG. 15 is a diagram illustrating how an image of interest becomes gradually similar to a reference image. Each image of interest has a value obtained by code-inverting the motion inferred. The image therefore approximates to the reference image as it is deformed.

Thereafter, the image composition unit 15 performs an averaging process, acquiring a high-resolution image.

FIG. 16 represents the concept of acquiring a high-resolution image IM101 by performing the first averaging method. In the first averaging method, the pixels of all frame images similar to the reference image, which correspond to one another in position, are added and averaged altogether, obtaining an average. Using the average as new pixel value, the unit 15 generates the high-resolution image IM10.

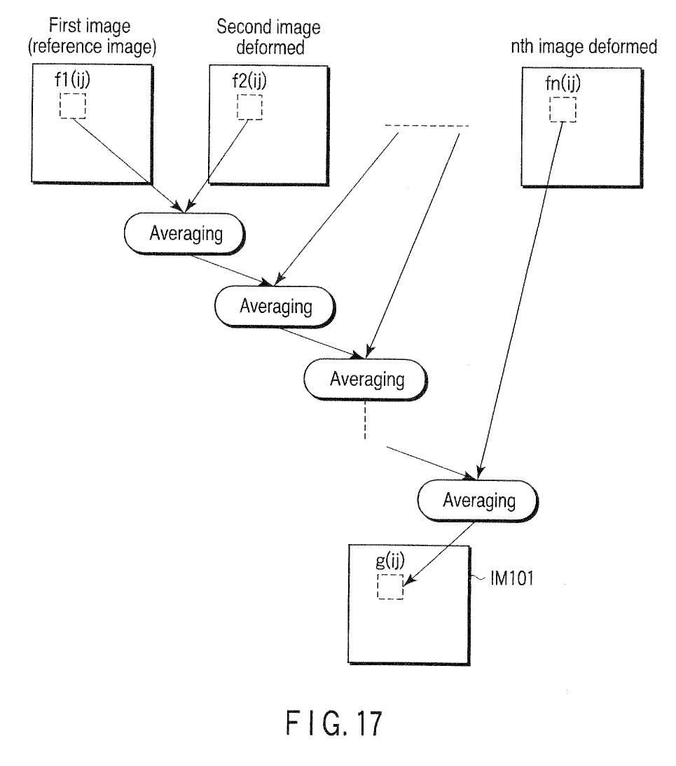

FIG. 17 represents the concept of acquiring a high-resolution image by performing the second averaging method. In the second averaging method, the pixels of the first and second frame images similar to the reference image, which correspond to each other in position, are added, providing a first average, this average is added to the pixel of the third frame image, which corresponds in position, thus generating a second average, and so forth. Using this average as new pixel value, the unit 15 generates an averaged image.

The first averaging method shown in FIG. 16 is advantageous over the second averaging method shown in FIG. 17, in that the noise will hardly be sustained.

One still picture may be generated from a plurality of images thus generated and evaluated highly. If so, this still picture can be a high-definition image having the resolution much enhanced because the data of the original image input to the object detection unit 11 has been fully utilized.

A moving picture may be generated from a plurality of images generated in time sequence. The moving picture can be a high-definition image, too, though not having so high a resolution as the still picture, because the data of the original image input to the object detection unit 11 has been fully utilized.

As has been described in detail, the first embodiment can generate a high-definition image that looks as natural and has high resolution, by selecting appropriate images from many frame images acquired when a moving object, such as a person's face, and then using the appropriate images in the process of generating a high-resolution image.

### Second Embodiment

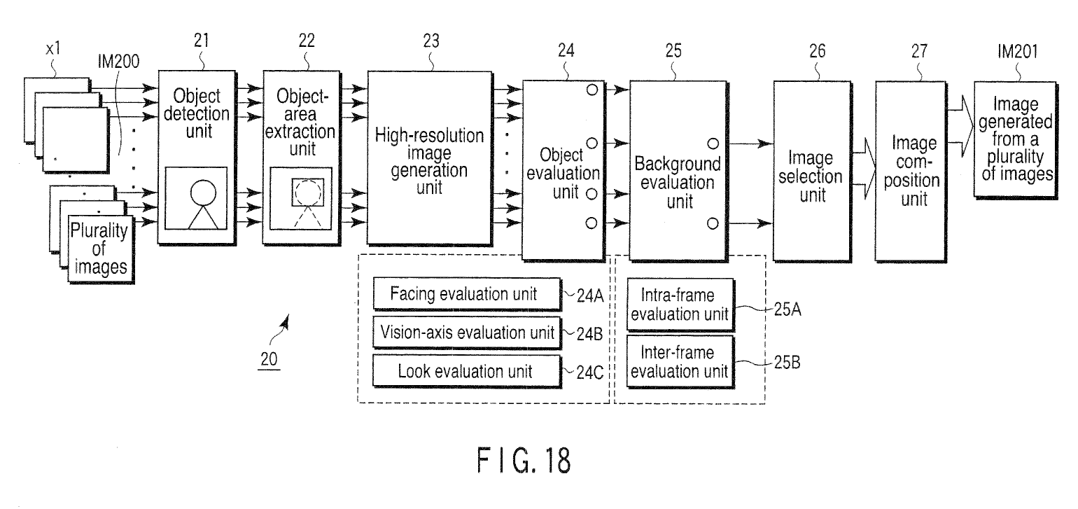

FIG. 18 is a diagram showing the configuration of an image processing apparatus 20 according to a second embodiment of this invention. As shown in FIG. 18, the image processing apparatus 20 comprises an object detection unit 21, an object-area extraction unit 22, a high-resolution image generation unit 23, an object evaluation unit 24, a background evaluation unit 25, an image selection unit 26, and an image composition unit 27.

The object detection unit 21 detects a specific object from a plurality of frame images IM200 acquired by a photographing apparatus (not shown), such as a digital camera, which is provided outside the image processing apparatus 20.

The object-area extraction unit 22 extracts the area in which the object detected by the object detection unit 21 exists, for example, a face area if the specific object is a person's face.

The high-resolution image generation unit 23 converts only the object area (i.e., face area) extracted by the object-area extraction unit 22, to a high-resolution image. The method the object-area extraction unit 22 performs to generate the high-resolution image is essentially identical to the method performed by the image selection unit 14 (FIG. 1). However, the method differs in that only the object area is extracted and converted to a high-resolution image to undergo the motion inference process and averaging process, not each frame image in its entirety as does the image selection unit 14 in the first embodiment.

The object evaluation unit 24 has a facing evaluation unit 24A, a vision-axis evaluation unit 24B, and an appearance evaluation unit 24C. The object evaluation unit 24 evaluates the object on the basis of the high-resolution image of the object, which has been generated by the high-resolution image generation unit 23.

The background evaluation unit 25 evaluates an image area other than the image area the object detection unit 21. The background evaluation unit 25 has an intra-frame evaluation unit 25A and an inter-frame evaluation unit 25B. The intra-frame evaluation unit 25A evaluates frame images, one by one. The inter-frame evaluation unit 25B evaluates a plurality of frame images, from the relation they have with other frame images.

The image selection unit 26 selects the image that the object evaluation unit 24 and the background evaluation unit 25 have evaluated as having the highest value.

The image composition unit 27 acquires a plurality of images the background evaluation unit 25 has selected. From the images acquired, the image composition unit 27 generates a plurality of images IM201, which will be described later.

The image composition unit 27 may be constituted by a high-resolution image generating apparatus configured to generate a high-definition image from a plurality of images. If this is the case, the unit 27 includes a motion inference unit and a high-resolution image generation unit. The motion inference unit infers an inter-frame motion from the image signals representing the images. The high-resolution image generation unit generates a high-resolution image from low-resolution images that displaced from one another as disclosed in Patent Document 2.

How this embodiment operates will be explained.

In the first embodiment, the image of the object, such as a person's face, may not be correctly evaluated if the image is not a clear because of the low resolution. The resolution of the image must therefore be increased to recognize the face area, particularly in order to achieve the vision-axis evaluation successfully.

In view of this, the high-resolution image generation unit 23 is used in the second embodiment, thereby increasing the resolution of the image of the face, which is used to evaluate the object. The accuracy of evaluation is thus enhanced.

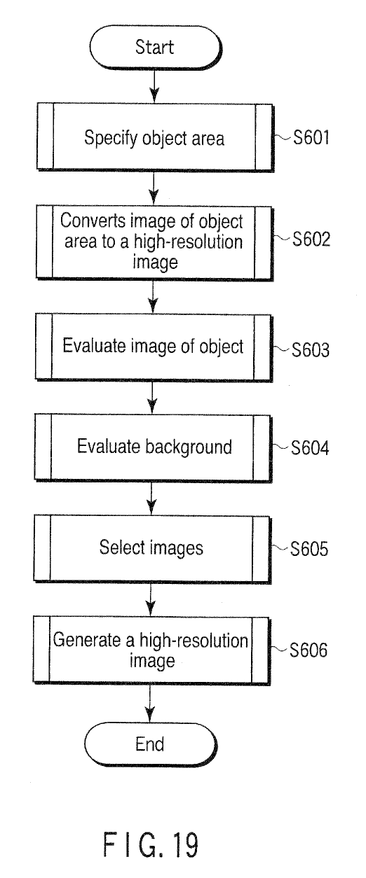

FIG. 19 is a flowchart that illustrates the main routine of the image processing the image processing apparatus 20 performs in the present embodiment.

First, a plurality of frame images IM200 are acquired from an external photographing apparatus. The object detection unit 21 performs a process of recognizing a specific object. Then, the object evaluation unit 22 specifies, as object area, a rectangular area in which the object specified exists (Step S601).

Next, the high-resolution image generation unit 23 converts the image of the object area specified in the specific-object recognition process, to a high-resolution image (Step S602).

Thereafter, the object evaluation unit 24 evaluates the high-resolution image generated by the high-resolution image generation unit 23, determining whether this image assumes an appropriate state (Step S603).

Further, the background evaluation unit 25 evaluates any image in that area other than the object area, determining whether this image assumes an appropriate state (Step S604).

In accordance with the results of evaluation performed by the object evaluation unit 24 and background evaluation unit 25, the image selection unit 26 selects a plurality of images. The images selected are output to the image composition unit 27 (Step S605).

Using at least the images the image selection unit 26 has selected, the image composition unit 27 generates an image that has a resolution higher than that of the frame images IM200 initially input (Step S606).

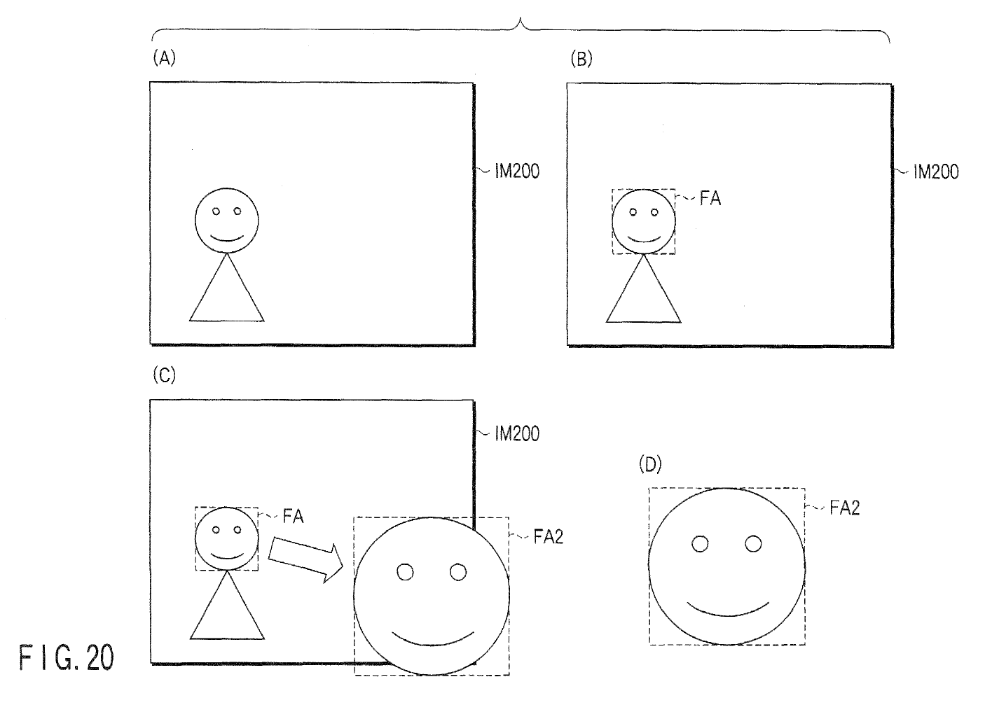

The process sequence that is performed if the specific object is a person's face will be explained with reference to FIG. 20. First, the image of face is extracted from each of the frame images IM200, as shown at (A) in FIG. 20. The method of extracting the image of face is identical to the method employed in the first embodiment.

Next, in Step S602 of specifying the object, the object evaluation unit 22 specifies the face area FA, i.e., object area, as a rectangle, as illustrated at (B) in FIG. 20.

Thereafter, in the process of generating a high-resolution image of the object, i.e., Step S603, the high-resolution image generation unit 23 generates such a high-resolution image FA2 of the face area FA as shown at (C) in FIG. 20.

Then, in Step S604, the object evaluation unit 24 evaluates the high-resolution image FA2 generated by the high-resolution image generation unit 23. The method of evaluating the image FA2 is identical to the method employed in the first embodiment. The processes the background evaluation unit 25, images the image selection unit 26 and image composition unit 27 perform are also similar to those the background evaluation unit 13, image selection unit 14 and image composition unit 15 perform in the first embodiment.

As described above, the image of face, used to evaluate the object, is converted to a high-resolution image, which is input to the object evaluation unit 24 in the second embodiment. This can increase the accuracy of evaluating the object. Images for use in generating a high-resolution image can therefore be selected, at high precision, from a plurality of frame images. As a result, the high-resolution image obtained has high precision.

### Third Embodiment

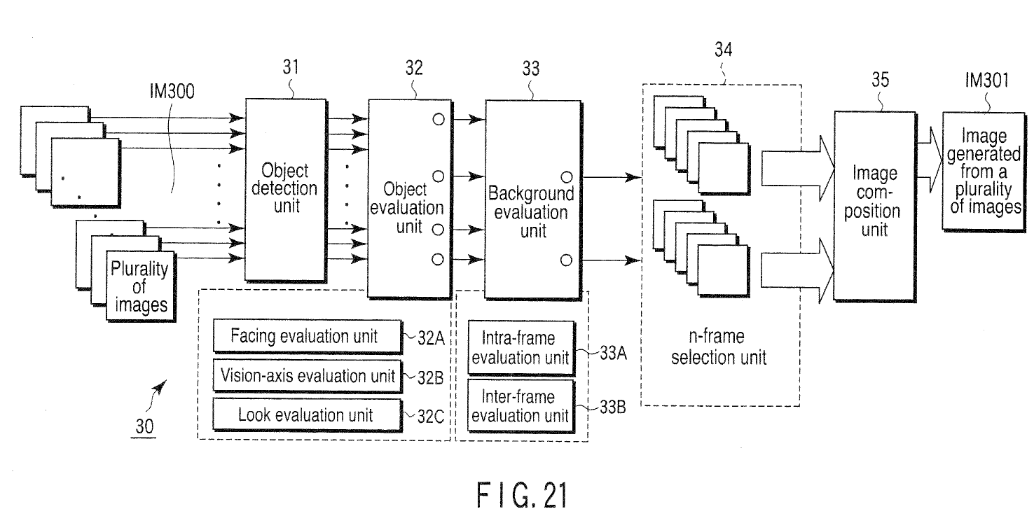

FIG. 21 is a block diagram showing the configuration of an image processing apparatus 30 according to a third embodiment of the present invention. As shown in FIG. 21, the image processing apparatus 30 comprises an object detection unit 31, an object evaluation unit 32, a background evaluation unit 33, an n-frame selection unit 34, and an image composition unit 35.

The object detection unit 31 detects a specific object from a plurality of frame images IM300 acquired by a photographing apparatus (not shown), such as a digital camera, which is provided outside the image processing apparatus 30.

As shown in FIG. 21, too, the object evaluation unit 32 has a facing evaluation unit 32A, a vision-axis evaluation unit 32B, and an appearance evaluation unit 32C. The object evaluation unit 32 evaluates the object on the basis of the high-resolution image of the object, which has been detected by the object detection unit 31.

The background evaluation unit 33 evaluates an image area other than the image area the object evaluation unit 32 has detected. The background evaluation unit 33 has an intra-frame evaluation unit 33A and an inter-frame evaluation unit 33B. The intra-frame evaluation unit 33A evaluates frame images, one by one. The inter-frame evaluation unit 33B evaluates a plurality of frame images, from the relation they have with other frame images.

The n-frame selection unit 34 selects n frames preceding, and other n frames following, any image highly evaluated by both the object evaluation unit 32 and the background evaluation unit 33. (Note that n is a natural number).

The image composition unit 35 receives a plurality of images the n-frame selection unit 34 has selected, or (2n+1)×m frame images (m: a natural number indicating the number of images highly evaluated). From these frame images, the image composition unit 35 generates a plurality of images IM301, which will be described later.

The image composition unit 35 may be constituted by a high-resolution image generating apparatus configured to generate a high-definition image from a plurality of images. In this case, the unit 35 includes a motion inference unit and a high-resolution image generation unit. The motion inference unit infers an inter-frame motion from the image signals representing the images. The high-resolution image generation unit generates a high-resolution image from low-resolution images that displaced from one another as disclosed in Patent Document 2.

How this embodiment operates will be explained.

If a high-resolution image is generated from only such highly evaluated images as images of the face, the other part of the image, e.g., the background, will not be a high-definition image. Consequently, no images of desirable high resolution may be obtained.

In view of this, of consecutive frame images, not only the image highly evaluated in terms of object area, but also some frame images preceding and following the image highly evaluated, in the third embodiment. The resolution of the image of the background is thereby enhanced in terms of resolution.

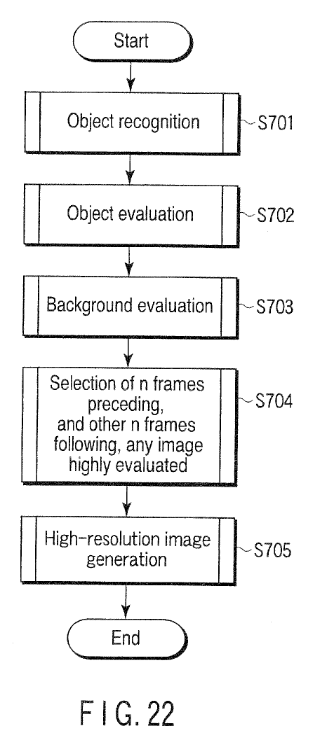

FIG. 22 is a flowchart that illustrates the main routine of the image processing the image processing apparatus 30 performs in the present embodiment.

First, a plurality of frame images IM300 are acquired from an external photographing apparatus. The object detection unit 31 performs a process of recognizing a specific object (Step S701).

Next, the object evaluation unit 32 evaluates the specific object recognized, determining whether this object assumes an appropriate state (Step S702).

Further, the background evaluation unit 33 evaluates any image in that area other than the object area, determining whether this image assumes an appropriate state (Step S703).

Thereafter, the n-frame selection unit 34 selects n frames preceding, and other n frames following, any image highly evaluated by both the object evaluation unit 32 and the background evaluation unit 33 (Step S704).

Using all images the image selection unit 26 has selected, the image composition unit 35 generates an image that has a resolution higher than that of the frame images IM300 initially input (Step S705).

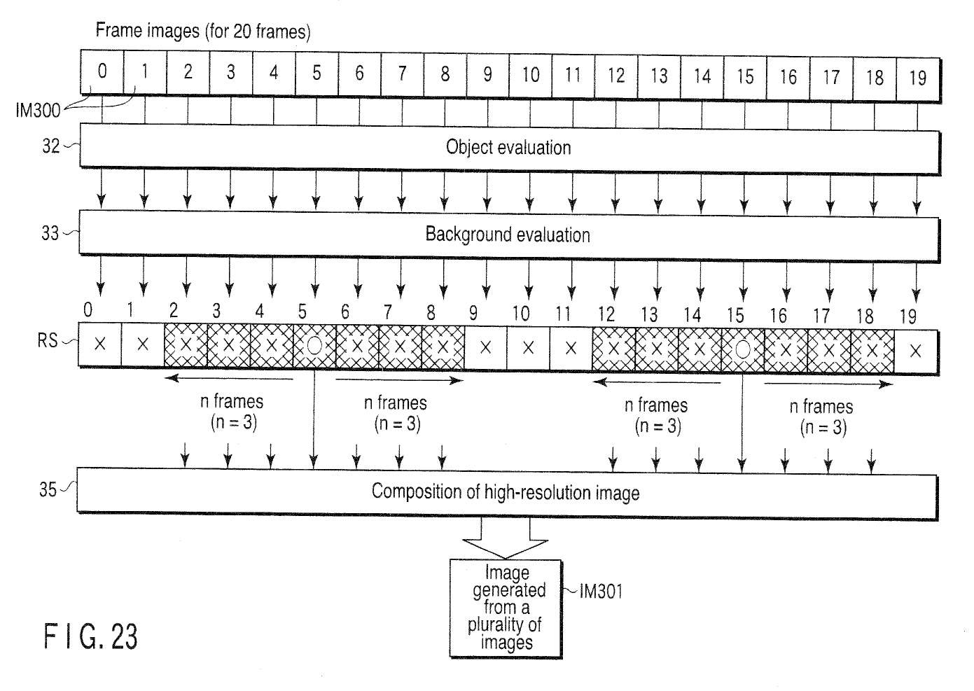

That is, the third embodiment operates in the same way as the first embodiment, until the image of object and the image of background are evaluated. The processes subsequent to the evaluation of the object and background will be described in detail, with reference to FIG. 23.

First, the object detection unit 32 evaluates the image of object, which the object detection unit 31 has detected from images IM300 for m frames (m: natural number greater than 1). FIG. 23 shows the case where m=20. Thus, the object detection unit 32 evaluates 20 frame images No. 0 to No. 19.

Assume that the object detection unit 32 determines that some of the frame images No. 0 to No. 19 are good ones. In the object evaluation result RS shown in FIG. 23, symbol “O” indicates a good frame image, and symbol “X” indicates a no-good frame image. In the case of FIG. 23, the frame image No. 5 and the frame image No. 15 have been valuated as good ones.

The n-frame selection unit 34 selects n frames preceding, and n frames following the frame image No. 5. Similarly, the unit 34 selects n frames preceding, and n frames following the frame image No. 15. In the case of FIG. 23, n=3. Therefore, the selected frame images are those shaded in FIG. 23. More precisely, seven frames Nos. 2 to 8 and seven frames Nos. 12 to 18 are selected in the case shown of FIG. 23.

Using all frame images thus selected (i.e., 14 frame images in the case of FIG. 23), the image composition unit 35 generates an image that has a resolution higher than that of the frame images IM300 initially input (Step S705).

Finally, the image composition unit 35 generates a high-resolution image IM301 from, for example, fourteen images in the instance of FIG. 23.

Alternatively, two high-resolution image may be generated, one from the frame images Nos. 2 to 8, and the other from the frame images Nos. 12 to 18.

As has been described, the third embodiment can generate not only an image of a specific object (e.g., person's face), which has been highly evaluated, but also a high-definition or high-resolution image of any part (e.g., background) other than the specific object.

The present invention has been described with reference to the first to third embodiments. Nevertheless, this invention is not limited to the embodiments. For example, a software program describing the various functions of any embodiment described above may be installed in a computer, and the computer may execute the program to perform the functions. In this case, the computer may be one incorporated as a control unit in a photographing apparatus such as a digital camera, a general-purpose one such as a personal computer, or one incorporated in a photograph storage apparatus or a printer apparatus and configured to perform simple image processing function.

Further, neither the method of evaluating the object nor the method of generating a high-resolution image is limited to the method explained in conjunction with the embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
an image acquisition unit configured to acquire a plurality of images;
an object recognition unit configured to recognize an object of interest existing in any one of the images acquired by the image acquisition unit;
a background evaluation unit configured to evaluate an image existing in an image area other than an image area showing the object of interest recognized by the object recognition unit;
an object evaluation unit configured to evaluate any image existing in the image area showing the object of interest recognized by the object recognition unit;
an image selection unit configured to select a plurality of images from the images in accordance with results of the evaluations performed by the background evaluation unit and object evaluation unit; and
an image composition unit configured to compose a new image by using the images selected by the image selection unit.

2. The image processing apparatus according to claim 1, wherein the image composition unit comprises a high-resolution image generation unit configured to generate a new still image from images including the images selected by the image selection unit, in accordance with the result of the evaluation performed by the evaluation unit, the new still image having a resolution higher than the resolution of any image selected by the image selection unit.

3. The image processing apparatus according to claim 1, wherein the background evaluation unit comprises an inter-frame evaluation unit configured to evaluate differences between peripheral areas of consecutive frame images.

4. The image processing apparatus according to claim 1, wherein the background evaluation unit comprises an intra-frame evaluation unit configured to evaluate an image.

5. The image processing apparatus according to claim 1, wherein the background evaluation unit comprises:
an inter-frame evaluation unit configured to evaluate differences between peripheral areas, from consecutive frame images; and
an intra-frame evaluation unit configured to evaluate an image.

6. The image processing apparatus according to claim 3 or 5, wherein the inter-frame evaluation unit calculates an optical flow between a plurality of frame images and evaluates differences between the frame images by comparing all calculated velocity vectors with velocity vectors peripheral to the calculated velocity vectors.

7. The image processing apparatus according to claim 3 or 5, wherein the inter-frame evaluation unit evaluates differences between a plurality of frame images.

8. The image processing apparatus according to claim 7, wherein the inter-frame evaluation unit calculates a differential image between any two adjacent frame images, calculates the number of pixels, larger than the difference, and evaluates an image from a ratio of the number of pixels to the number of pixels defining an source image.

9. The image processing apparatus according to claim 4 or 5, wherein the intra-frame evaluation unit evaluates an image from a ratio of dark part of the image to a light part thereof.

10. The image processing apparatus according to claim 1, wherein the image composition unit composes a new image from the images selected by the image selection unit, the new image having a resolution higher than the resolution of any image acquired by the an image acquisition unit.

11. The image processing apparatus according to claim 1, wherein the image acquisition unit acquires a plurality of images generated in time sequence, and the image selection unit selects an image evaluated to some degree by the object evaluation unit and an image adjacent, in time sequence, to the image so selected.

12. The image processing apparatus according to claim 1, wherein the object evaluation unit performs a process of enhancing resolution of at least one area of each image and evaluates the image having the area so enhanced in term of resolution.

13. The image processing apparatus according to claim 1, wherein the object recognition unit recognizes an area showing a person's face as the object of interest, the object evaluation unit calculates an index representing the recognition degree of the person's face, and evaluates the object in accordance with the index.

14. An image processing method comprising:
an image acquisition step of acquiring a plurality of images;
an object recognition step of recognizing an object of interest existing in any one of the images acquired by the image acquisition step;
a background evaluation step of evaluating an image existing in an image area other than an image area showing the object of interest recognized in the object recognition step;
an object evaluation step of evaluating any image existing in the image area showing the object of interest recognized in the object recognition step;
an image selection step of selecting a plurality of images from the images in accordance with results of the evaluations performed in the background evaluation step and object evaluation step; and
an image composition step of composing a new image by using the images selected by the image selection unit.

15. The image processing method according to claim 14, wherein in the image composition step, a new image is generated from images selected in the image selection step, the still image having a resolution higher than the resolution of any image acquired in the image acquisition step.

16. The image processing method according to claim 14, wherein the background evaluation step has an inter-frame evaluation step of evaluating differences between peripheral areas of consecutive frame images.

17. The image processing method according to claim 14, wherein the background evaluation step has an intra-frame evaluation step of evaluating a plurality of frame images from one image.

18. The image processing method according to claim 14, wherein the background evaluation step comprises:
an inter-frame evaluation step of evaluating differences between peripheral areas, from consecutive frame images; and
an intra-frame evaluation step of evaluating an image from another image.

19. The image processing method according to claim 16 or 18, wherein in the inter-frame evaluation step, an optical flow between a plurality of frame images is calculated, and all calculated velocity vectors are compared with velocity vectors peripheral to the calculated velocity vectors, thereby to evaluate the frame images.

20. The image processing method according to claim 16 or 18, wherein in the inter-frame evaluation step, differences between a plurality of frame images are evaluated.

21. The image processing method according to claim 20, wherein in the inter-frame evaluation step, a differential image between any two adjacent frame images is calculated, the number of pixels, larger than the difference, is calculated, and an image is evaluated from a ratio of the number of pixels to the number of pixels defining an source image.

22. A recording medium in which an image processing program for generating a new image from a plurality of images is electronically recorded, the program describing an image acquisition process of acquiring a plurality of images;
an object recognition process of recognizing an object of interest existing in any one of the images acquired in the image acquisition process;
a background evaluation step of evaluating an image existing in an image area other than an image area showing the object of interest recognized in the object recognition process;
an object evaluation process of evaluating any image existing in the image area showing the object of interest recognized in the object recognition process;
an image selection process of selecting a plurality of images from the images in accordance with results of the evaluations performed in the background evaluation process and object evaluation process; and
an image composition process of composing a new image by using the images selected in the image selection process.
